(19) United States
(12) Patent Application Publication
(10) Pub. No.: US 2008/0319132 A1
(43) Pub. Date: Dec. 25, 2008

(54) Amorphous Polyester Urethane Networks Having Shape Memory Properties

(75) Inventors: Andreas Lendlein, Berlin (DE); Armin Alteheld, Bad Kreuznach (DE)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Mnemoscience GmbH, Uebach- Palenberg (DE)

(21) Appl. No.: 10/570,073

(22) PCT Filed: Aug. 16, 2004
(86) PCT No.: PCT/EP2004/009180

§ 371 Date: Sep. 8, 2008

(30) Foreign Application Priority Data
Sep. 2, 2003 (DE) 103 40 392.2

(51) Int. Cl. C08L 75/00; C08G 18/48; C08G 18/42

(52) U.S. Cl. 525/123; 528/76; 528/84; 525/418; 525/450; 525/453

(57) ABSTRACT

In order to avoid structural heterogeneities in the networks, in accordance with the invention under consideration, a novel system of amorphous polymer networks comprising one or several segments with shape memory properties is provided. The networks are preferably composed of biodegradable and biocompatible components and open up the possibility for use in the medical domain. The systemic character of the materials allows the thermal and mechanical properties as well as the decomposition behavior to be adjusted in a specific manner. The invention under consideration particularly makes it possible to produce polyphase amorphous networks.

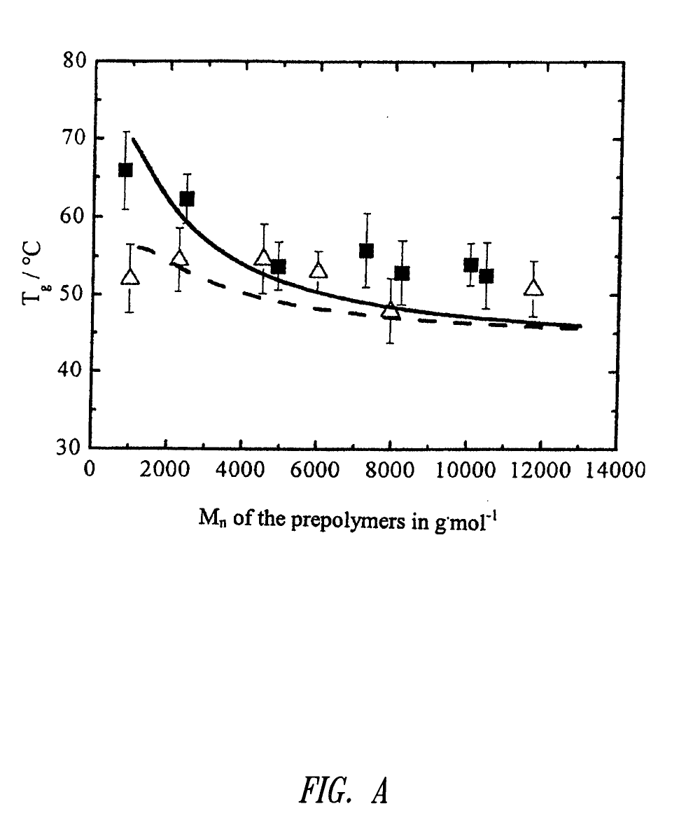

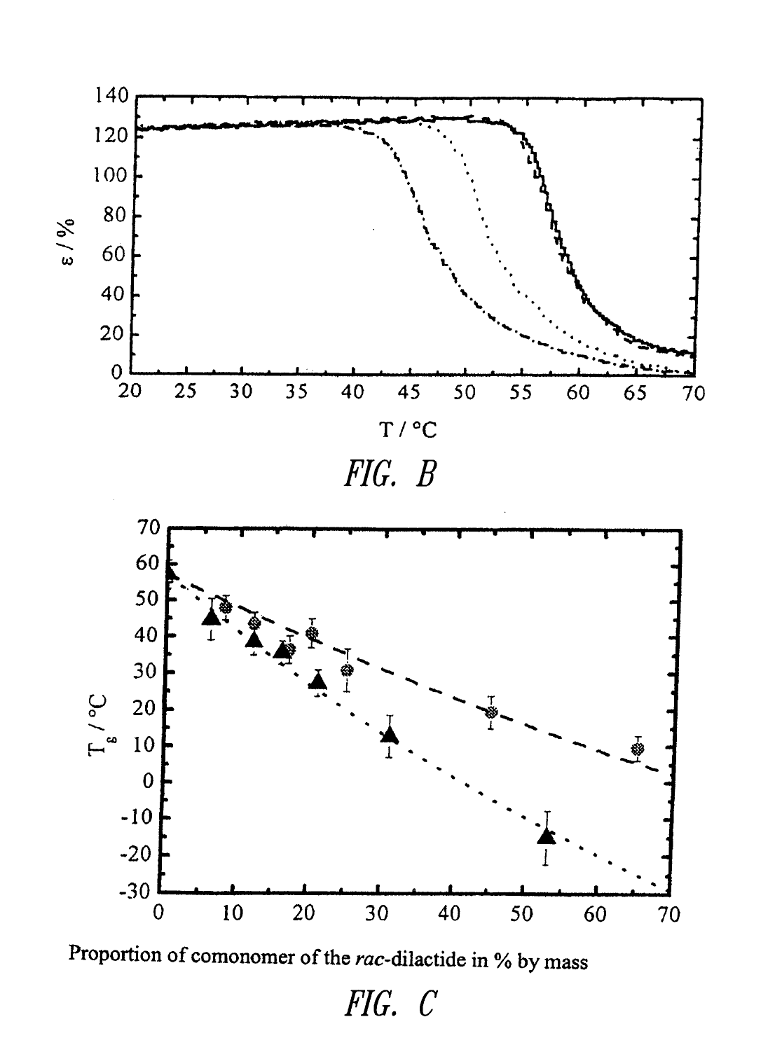

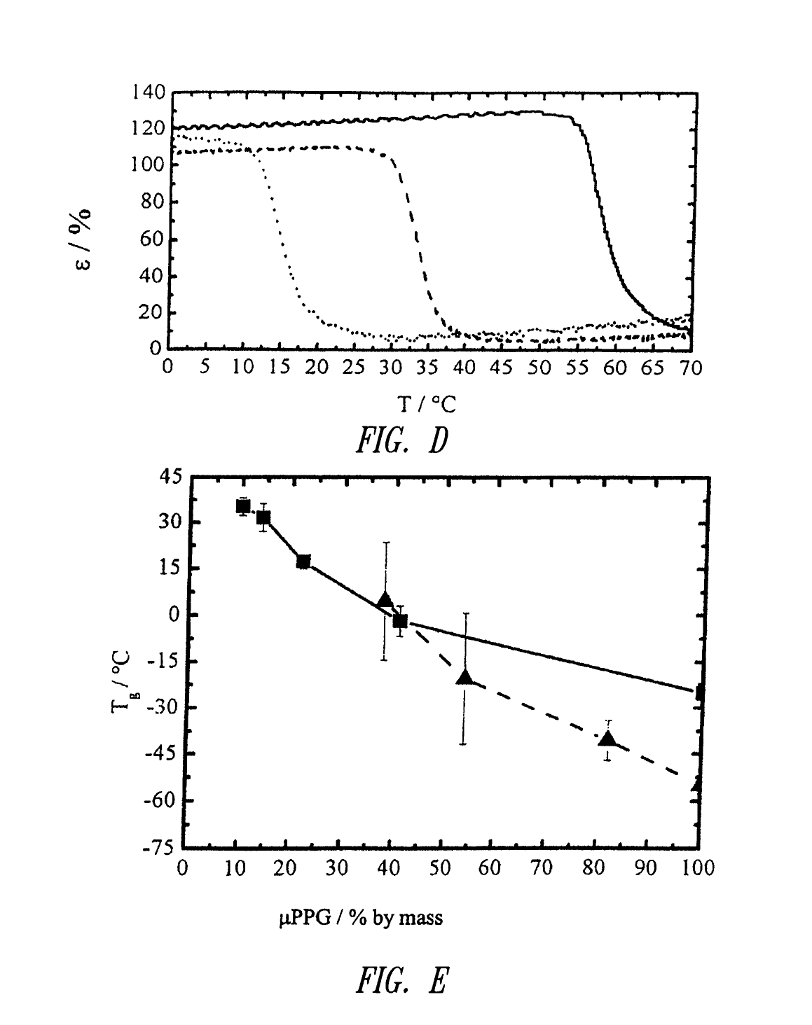

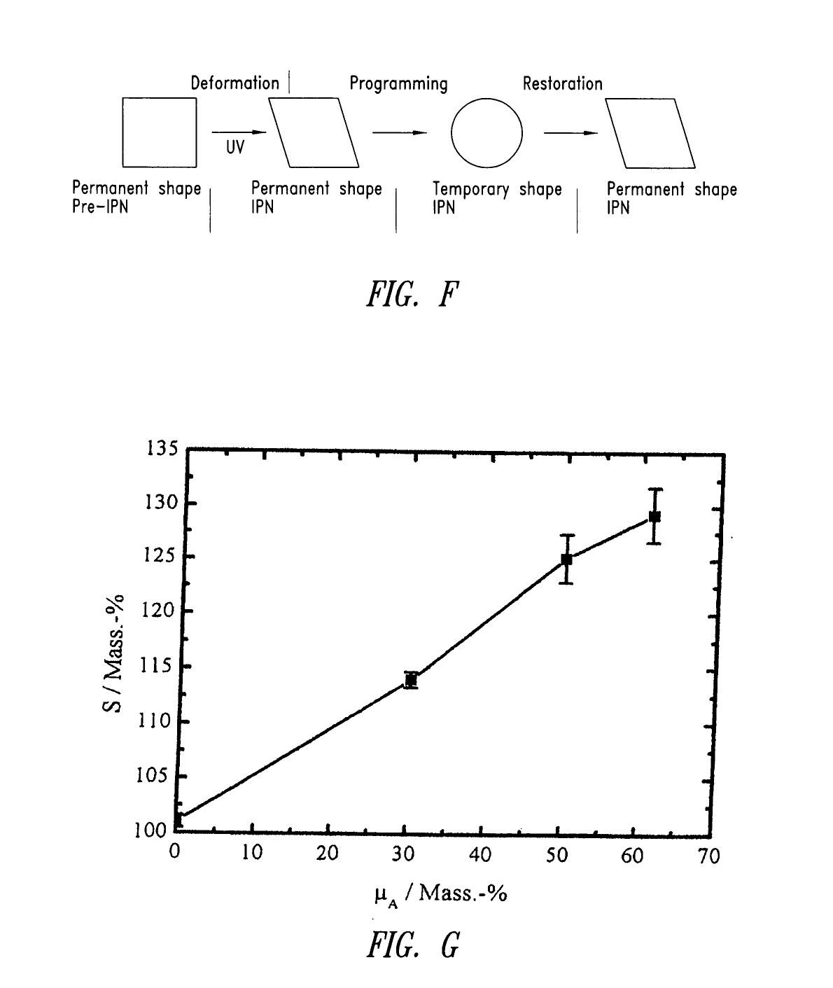

The invention under consideration relates to cross-linked, preferably biodegradable polyester urethanes with shape memory properties.

### STATE OF THE ART

Biodegradable, covalent polymer networks with shape memory properties are usually obtained by means of free radical polymerization of, e.g., macrodimethacrylates. This method of production comprises a total of three steps: synthesis of macrodiols, methacrylation of the terminal groups and radical cross-linking.

The radical reaction mechanism is subject to a random process in which the microscopic structure of the cross-link points can be regulated only to a limited degree, so that structural heterogeneities can arise in the networks. Furthermore, with a chain reaction of that type, regulation and checking of the reaction is difficult, so that even if the starting materials in the network itself are very uniform, widely varying areas may be present, e.g., areas having a high cross-link density and areas having a lower cross-link density. This affects the use of materials of this type in some application areas, however. At the same time, such heterogeneities can also lead to variability in the physical properties.

### OBJECT OF THE INVENTION

The object of the invention under consideration is, therefore, to provide a new material and accompanying method for production with which the disadvantages of the state of the art can be overcome.

### SHORT DESCRIPTION OF THE INVENTION

The object described above was solved by means of the polyurethane network according to Claim 1, as well as by means of the method defined in Claim 10. Preferred embodiments are specified in the sub-claims.

### DETAILED DESCRIPTION OF THE INVENTION

In order to avoid structural heterogeneities in the networks, the invention under consideration provides a novel system of amorphous polymer networks comprising one or several segments with shape memory properties. The networks are preferably composed of biodegradable and biocompatible components and they open up the possibility for use in the medical domain. The systemic character of the materials allows the thermal and mechanical properties, as well as the decomposition behavior, to be adjusted in a specific manner. In particular, the invention under consideration makes it possible to produce polyphase amorphous networks.

In contrast to the already developed biodegradable, covalent polymer networks with shape memory properties, which are obtained by means of free radical polymerization of, for example, macro-dimethacrylates, the invention under consideration calls for the use of a different method of production, namely polyaddition. In this process, a total of only two synthesis steps are necessary: synthesis of macrotriols or macrotetrols and polyaddition.

The networks according to the invention are based on star-shaped prepolymers with hydroxyl terminal groups, which are produced using known methods. This procedure makes it possible to produce structurally uniform networks (particularly even on a larger scale). By means of starting the production with multifunctional prepolymers, it is possible to ensure a very high degree of homogeneity of the networks, because the essential parameters of the networks can be specified just by the comparably low-molecular parent compounds as a result of the number of possible coupling points and the chain lengths of the prepolymers, which simplifies the control. At the same time, the cross-link points themselves are also already pre-shaped, which further facilitates the control.

The networks according to the invention comprise multifunctional constitutional units (derived from the abovementioned prepolymers), preferably trifunctional and/or tetrafunctional constitutional units, each of which preferably has a hydroxyfunctionality at the reactive ends or an equivalent grouping before the production of the network. The production of the network then takes place by reaction with a suitable diisocyanate or another suitable compound, preferably with a slight excess of diisocyanate.

The multifunctional constitutional units (prepolymers) comprise a central unit, which corresponds to the later cross-link points in the network. This central unit is preferably derived from suitable low-molecular multifunctional compounds, preferably with three or more hydroxyl groups, in particular, three to five and, more preferably, three or four hydroxyl groups. Suitable examples are pentaerythritol and 1,1,1-tris(hydroxymethyl)ethane. An appropriate number of prepolymer chains (corresponding, for example, to the number of hydroxyl groups) is bound to this central unit, wherein these chains preferably comprise monomer units bound by ester bonds and/or monomer units bound by ether bonds. Preferred examples are chains on the basis of lactic acid, caprolactone, dioxanone, glycolic acid and/or ethylene glycol or propylene glycol.

Preferred in this case are, in particular, chains of lactic acid (D or L or DL), optionally in combination with one of the other abovementioned acid constitutional units (as block copolymers or as statistical copolymers, wherein statistical copolymers are preferred). Alternatively, the chains comprise segments from the acid constitutional units (in the possible combinations mentioned above), together with segments from the ether constitutional units, wherein a combination with a polypropylene glycol segment is particularly preferred here. Preferably, such constitutional units possess two segments in each chain: a polyester segment and a polyether segment (particularly polypropylene glycol), wherein it is preferred for the polyether segment to be provided at the central unit, with the polyester segment affixed thereto, so that the chain ends are formed by the polyester segment.

The prepolymers normally have a number-average molecular weight (determined by GPS) of from 1,000 to 20,000 g/mol, preferably from 2,500 to 15,000 g/mol, particularly from 5,000 to 12,000 g/mol and furthermore preferably from 8,000 to 11,000 g/mol. In the case of prepolymers with segments of polyether units, the segments of polyether units preferably have a number-average molecular weight of from 1,000 to 6,000, and the polyester segments coupled thereto have a number-average molecular weight of from 1,000 to 12,000 g/mol, so that these prepolymers altogether again have a number-average molecular weight as described above.

Because prepolymers of this type can be produced by means of easily controlled methods, the prepolymers used in accordance with the invention preferably have a relatively large degree of homogeneity (PD), preferably in the range of from 1 to 2, particularly from 1 to 1.5. A good degree of homogeneity of this type also gives the networks according to the invention a good degree of homogeneity.

It is particularly preferred if the prepolymers have lactic acid units (lactate units). If further acid constitutional units are present, the lactate units preferably account for the greater portion of the acid units in the polyester segment. For the other abovementioned acid constitutional units, preferred proportions, in addition to lactate units, are as follows:
Glycolate: 0 to 55% by mass, preferably 10 to 30% by mass.
Caprolactone or dioxanone: 0 to 45% by mass, preferably 10 to 25% by mass, particularly roughly 15% by mass.
   The respective proportions can easily be adjusted by checking the quantity of monomers in the production of the prepolymers.

The prepolymers constructed as described above are reacted into the networks according to the invention by a polyaddition reaction. In this process, the reaction with the diisocyanates results in a chain linkage to the hydroxyl groups at the ends of the multifunctional prepolymers, so that the chains are then connected via diurethane units. Because of the hydrolysis sensitivity of the individual segments, this results in the development of a network that can be biodegradable, particularly in the physiological area. The selection of the components for the prepolymers furthermore particularly also allows the production of amorphous networks. In particular, the use of lactic acid (preferably DL form) and the use of atactic polypropylene glycol allow the production of completely amorphous networks.

In this process, the decomposition behaviour can be controlled by means of the proportion of individual monomers. Glycolate units, caprolactone units and dioxanone units generally delay the decomposition reaction.

Furthermore, the mechanical property profile of the network can also be controlled by means of the chain length and the respective proportion of monomers. Low molar masses of the prepolymers normally lead to networks with a high cross-link density, which can possibly have low mechanical stabilities, however. In return, the swelling capacity of such networks is limited.

The introduction of glycolate units, caprolactone units and/or dioxanone units furthermore allows control of the transition temperature and therefore the switch temperature for the shape memory effect (the shape memory effect is already extensively described in the state of the art; in this context, therefore, reference is merely made to the already existing literature, e.g., further patent applications made by the Mnemoscience company). In this way, desired switch temperatures can be selectively adjusted for an application.

The prepolymers according to the invention additionally also allow the production of phase-segregated networks, which is advantageous for some application areas. The following strategies lend themselves to the production of such phase-segregated networks.
1. Prepolymers according to the invention having only polyester segments are reacted with diisocyanate in the presence of polyether macromonomers with unsaturated terminal groups. These polyether macromonomers are then photochemically cross-linked, resulting in an IPN.
2. Prepolymers according to the invention having both polyester segments and polyether segments are reacted with diisocyanate. The result is a network with segregated phases.
3. Prepolymers according to the invention having only polyester segments are reacted with diisocyanate with prepolymers with only polyether segments. The result is a network with segregated phases, wherein, unlike in 2., polyester segments and polyether segments are not present in one prepolymer, but instead in separate prepolymers, coupled via diurethane units.
4. Prepolymers according to the invention having only polyester segments are reacted with diisocyanate. The resulting network is swollen in the presence of acrylate monomers and the acrylate monomers intercalated in this way are then photochemically cross-linked into a network, resulting in an IPN.
   Preferred molecular weights for the macromonomers (1.) correspond to the values specified above for the polyether segment in the prepolymer. Also preferred here is a polypropylene glycol segment.

Preferred acrylate monomers for option 4. are ethyl acrylate, butyl acrylate, hexyl acrylate and hydroxyethyl acrylate, as well as the corresponding methacrylates. The total mass proportion in the resulting IPN for these monomers preferably amounts to from 1 to 35% by mass, more strongly preferred from 8 to 25% by mass. Hydroxyethyl acrylate particularly allows an adjustment of the hydrophilicity of the IPN.

Preferred networks according to the invention are as follows:
Type I: Polymer networks of triols or tetrols and diisocyanate,
Type II: Polymer networks of triols and tetrols and diisocyanate,
Type III: Polymer networks of triols or tetrols with diisocyanate and an interpenetrating network of a macrodimethacrylate,
Type IV: Sequential interpenetrating polymer networks of a network of triols or tetrols with diisocyanate and subsequently polymerized low-molecular acrylates.
   The networks according to the invention can be used in all areas in which biocompatible or degradable materials are used, e.g., in the medical area.

The networks according to the invention can possess additional constituents, such as filling substances, biologically active substances, colouring substances, diagnostics, etc. The use of such additional constituents depends on the particular purpose.

### SHORT DESCRIPTION OF THE FIGURES

FIG. A shows the glass temperature of the polyurethane networks (Type 1) with oligo[(rac-lactate)-co-glycolate] segments having various segment lengths.

FIG. B illustrates the restoration behaviour (shape memory effect) of a previously elongated network (Type 1) with oligo[(rac-lactate)-co-glycolate] segments in the heating process.

FIG. C shows the glass temperature of the polyurethane networks (Type 1) with oligo(lactate-co-hydroxycaproate) and oligo(lactate-hydroxyethoxy acetate) segments with variable lactate content.

FIG. D illustrates the restoration behavior (shape memory effect) of several polyurethane networks (Type 1) from FIG. C in the heating process.

FIG. E represents the thermal properties of the multiphase polymer networks (Type 1) with oligo(propylene glycol) and oligo(lactate-co-glycolate) segments.

FIG. F is a schematic depiction of the fixation of a pre-IPN by the subsequent cross-linking of the additional component (Type III).

FIG. G shows the swelling capability of an IPN (Type IV) in water with a variable proportion of 2(hydroxyethyl) acrylate.

### PRODUCTION OF THE NETWORKS

The networks according to the invention can be simply obtained by means of the reaction of the prepolymers with diisocyanate in solution, e.g., in dichloromethane, and subsequent drying (Types 1 and II). In the production of the IPN with a second network of acrylate monomers, the network according to the invention is swollen in monomers after the production, whereupon the cross-linking of the monomers (Type IV) follows. In the case of the IPN with a second network of polypropylene glycol macromonomers, the network according to the invention is produced in the presence of the macromonomers (in solution, as described above), which are subsequently cross-linked (Type III). In principle, mass polymerization is also possible, i.e., crosslinking reactions without the use of a solvent. This option is particularly useful in view of a processing of the materials according to the invention in injection moulding, because the thermoplastic starting materials are shaped in this process, whereupon the crosslinking into the desired shape follows.

### EXAMPLES

The following examples illustrate the invention under consideration.

Abbreviated designations of the oligomers and the polymer networks

Cooligomers of the rac-dilactide

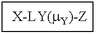

X Initiator of the ring-opening polymerization

E Ethylene glycol

P Pentaerythrite

T 1,1,1-Tris(hydroxymethyl)ethane
L rac-lactate
Y Comonomer units

C ε-hydroxycaproate

D β-hydroxyethoxy acetate

G Glycolate
μ_{Y} Proportion by mass of the comonomer Y according to ¹H-NMR relative to the total mass of the repeating units without initiator segment in % by mass
Z According to the initial weight of the reactands, expected number-average molar mass of the oligomers in g·mol⁻¹ rounded to 1,000 g·mol⁻¹
   Oligo(propylene glycol)

F-PPG-Z
F Terminal groups

D Diol

M Dimethacrylate

T Triol
PPG Oligo(propylene glycol)
Z Number-average molar mass of the hydroxyfunctional oligomers according to manufacturer's information, in g·mol⁻¹; exception: M-PPG-560: in this case, Z is the number-average molar mass of the macrodimethacrylate according to manufacturer's information, in g mol⁻¹
   Star-{oligo(propylene glycol)-block-oligo[(rac-lactate)-co-glvcolate]}triols

T-PPG-Z-b-LG-Z
T-PPG Commercially obtainable oligo(propylene glycol)triol prepared by initiation with glycerin
Z Number-average molar mass of the oligo(propylene glycol)triol used according to manufacturer's information, in g·mol⁻¹
b Block sequence structure
LG Oligo[(rac-lactate)-co-glycolate] segment with 15% by mass glycolate according to initial weight
Z According to the initial weight of the reactands, expected number-average molar mass of the star-{oligo(propylene glycol)-block-oligo[(rac-lactate)-co-glycolate]}triol, in g·mol⁻¹

### Networks (Except for Interpenetrating Polymer Networks)

The designations for the prepolymers used with the prefix N apply.

An exception is given by the networks that are produced by polyaddition of mixtures of oligo(propylene glycol)triols, oligo[(rac-lactate)-co-glycolate] tetrols and TMDI. In this case, the following abbreviated designations apply:

N-T-PPG(μ_{PPG})-Z-LG
N Network
T-PPG Commercially obtainable oligo(propylene glycol)triol prepared by initiation with glycerin
μ_{PPG} Proportion by mass of the oligo(propylene glycol) triol used, relative to the total mass of the prepolymers, in % by mass
Z Number-average molar mass of the oligo(propylene glycol) triol according to manufacturer's information, in g·mol⁻¹
LG Oligo[(rac-lactate)-co-glycolate] tetrol P-LG(17)-10000

The networks N-EA, N-BA and N-HEA form additional exceptions. These are networks that are obtained by means of photochemically initiated polymerization of ethyl acrylate, butyl acrylate or (2-hydroxyethyl)acrylate. A volume of 0.5% by volume of the oligo(propylene glycol)dimethacrylate M-PPG-560 and the photoinitiator 2,2′-dimethoxy-2-phenylacetophenone (10 mg/mL) is added to the acrylates.

### Interpenetrating Polymer Networks

N-LG-ipX-N-Y(μ_{Y})-Z
N-LG Network of N-P-LG(17)-10000 and TMDI
ip Interpenetrating polymer network
X Number of steps in which swelling and radiation take place (optional); if X=1, not explicitly mentioned
N-Y Network of oligo(propylene glycol)dimethacrylate and the component Y:
   EA Ethyl acrylate
   BA Butyl acrylate
   HEA (2-hydroxyethyl)acrylate
   M-PPG Oligo(propylene glycol)dimethacrylate
μ_{Y} Proportion of the component Y in % by mass; in the case of in situ sequential IPNs, according to the initial weight of oligo(propylene glycol)dimethacrylate
Z Molar mass of the oligo(propylene glycol)diol used in the synthesis of the macrodimethacrylate; if M-PPG-560 is used, not explicitly mentioned

In the case of interpenetrating systems whose components Y are prepared in a non-cross-linked form, (pre-IPNs), the auxiliary N is dropped in front of this component.

### Prepolymers (Macrotriols and Macrotetrols)

The preparation of star-shaped prepolymers such as oligo[(rac-lactate)-co-glycolate]triol or -tetrol is done by means of ring-opening copolymerization of rac-dilactide and diglycolide in the melting of the monomers with hydroxyfunctional initiators, with the addition of the catalyst dibutyltin (IV) oxide (DBTO). This synthesis path had proven to be suitable in the literature on the production of linear and branched oligomers with defined molar mass and terminal group functionality (D. K. Han, J. A. Hubbell, Macromolecules 29, 5233 (1996); D. K. Han, J. A. Hubbell, Macromolecules 30, 6077 (1997); R. F. Storey, J. S. Wiggins, A. D. Puckett, J. Polym. Sci.: Part A: Polym. Chem. 32, 2345 (1994); S. H. Kim. Y.-K. Han, Y. H. Kim, S. I. Hong, Makromol. Chem. 193, 1623 (1992)). Ethylene glycol, 1,1,1-tris(hydroxy-methyl)ethane or pentaerythrite are used as initiators of the ring-opening polymerization.

Oligo(lactate-co-hydroxycaproate) tetrols and oligo(lactate-hydroxyethoxy acetate) tetrols, as well as [oligo(propylene glycol)-block-oligo(rac-lactate)-co-glycolate)] triols are produced in a similar fashion.

TABLE 1
Composition and molecular weight of the prepolymers oligo[(rac-lactate)-co-glycolate]s. χ_{G} molar
proportion of glycolate units, μ_{G} mass proportion of glycolate units, number-average
relative molar mass Mₙ and polydispersity PD, according to ¹H-NMR spectroscopy (¹H-NMR), vapour
pressure osmometry (VPO) and gel permeation chromatography (GPC). The proportion by
mass of glycolate used in the reaction batch is μ_{G}_{_{—}}_{R} and M_{calc} is the number-average molar
mass expected on the basis of the initial weight of the reactands.

| | | | | | Mₙ^{b)} | Mₙ | Mₙ | |
|---|---|---|---|---|---|---|---|---|
| | μ_{G}_{_{—}}_{R} | χ_{G}^{b)} | μ_{G}^{b)} | M_{calc} | (¹H-NMR) | (VPO) | (GPC) | PD |
| Oligomer^{a)} | % by mass | mol % | % by mass | g · mol⁻¹ | g · mol⁻¹ | g · mol⁻¹ | g · mol⁻¹ | (GPC) |
| E-LG(15)-1000 | 15 | 18 | 15 | 1100 | 1100 | n.d. | 1200 | 1.56 |
| E-LG(17)-2000 | 15 | 20 | 17 | 2100 | 2000 | 1800 | 2300 | 1.63 |
| E-LG(15)-5000 | 15 | 18 | 15 | 5100 | 5000 | n.d.^{c)} | 5600 | 1.44 |
| E-LG(17)-7000 | 15 | 20 | 17 | 7100 | 6200 | 4200 | 5400 | 1.67 |
| E-LG(16)-9000 | 15 | 19 | 16 | 9100 | 9500 | 5600 | 7900 | 1.60 |
| E-LG(15)-12000 | 15 | 18 | 15 | 12000 | 12500 | 4400 | 6200 | 1.75 |
| T-LG(17)-1000 | 15 | 20 | 17 | 1100 | 980 | n.d.^{c)} | 970 | 1.49 |
| T-LG(15)-2000 | 15 | 18 | 15 | 2100 | 2300 | 1900 | 2800 | 1.40 |
| T-LG(17)-5000 | 15 | 20 | 17 | 5100 | 4500 | 3100 | 4400 | 1.43 |
| T-LG(17)-7000 | 15 | 20 | 17 | 7100 | 6000 | 4200 | 7200 | 1.41 |
| T-LG(16)-9000 | 15 | 19 | 16 | 9200 | 7900 | 7700 | 9600 | 1.42 |
| T-LG(16)-10000 | 15 | 19 | 16 | 10100 | 9200 | 4700 | 6400 | 1.60 |
| T-LG(18)-12000 | 15 | 21 | 18 | 12200 | 11700 | 6,000 | 7600 | 1.64 |
| P-LG(17)-1000 | 15 | 20 | 17 | 1100 | 820 | 1300 | 760 | 1.92 |
| P-LG(18)-2000 | 15 | 21 | 18 | 2100 | 2500 | n.d.^{c)} | 5400 | 1.11 |
| P-LG(15)-5000 | 15 | 18 | 15 | 5100 | 4900 | 4000 | 7600 | 1.23 |
| P-LG(15)-7000 | 15 | 18 | 15 | 7100 | 7300 | 4700 | 8000 | 1.30 |
| P-LG(16)-9000 | 15 | 19 | 16 | 9100 | 8200 | 4200 | 6300 | 1.91 |
| P-LG(17)-10000 | 15 | 18 | 17 | 10100 | 10500 | 5100 | 10800 | 1.60 |
| P-LG(12)-12000 | 15 | 15 | 12 | 12100 | 10100 | 8700 | 14400 | 1.24 |
| P-LG(0)-10000 | 0 | 0 | 0 | 10100 | 9200 | 6700 | 11100 | 1.21 |
| P-LG(8)-10000 | 8 | 10 | 8 | 10100 | 11600 | 9200 | 13400 | 1.13 |
| P-LG(13)-10000 | 10 | 16 | 13 | 10100 | 10500 | 9700 | 14000 | 1.27 |
| P-LG(30)-10000 | 30 | 35 | 30 | 10100 | 10700 | 7400 | 9200 | 1.41 |
| P-LG(48)-10000 | 50 | 53 | 48 | 10100 | 9700 | 6100 | 10800 | 1.36 |
| P-LG(52)-10000 | 50 | 57 | 52 | 10100 | 9900 | 7800 | 12600 | 1.21 |

^{a)}Explanation of the abbreviations: see above.
^{b)}The molar proportion of glycolate units χ_{G} is calculated using the¹H-NMR spectra and converted into proportions by mass μ_{G}. The determination of the composition of the oligomers and the calculation of Mₙ according to ¹H-NMR are described in Chap. 12.2.1.
^{c)}n.d.: not determined
E = Ethylene glycol
P = Pentaerythrite
T = 1,1,1-tris(hydroxymethyl)ethane

TABLE 1a
Molar χ_{D} or mass proportion μ_{D} of β-hydroxyethoxy acetate, number-average molar mass
Mₙ, and polydispersity PD of the oligo[(rac-lactate)-co(β-hydroxyethoxy acetate)]s according
to ¹H-NMR spectroscopy (¹H-NMR), vapour pressure osmometry (VPO) and gel permeation chromatography
(GPC). The proportion by mass of β-hydroxyethoxy acetate used is μ_{D}_{_{—}}_{R} and M_{calc} is the number-average
molar mass expected on the basis of the initial weight of the reactands according to Eq. 4.2.
The prepolymers are prepared by initiation with pentaerythrite.

| | | | | | Mₙ^{b)} | Mₙ | Mₙ | |
|---|---|---|---|---|---|---|---|---|
| | μ_{D}_{_{—}}_{R} | χ_{D}b) | μ_{D}^{b)} | M_{calc} | (¹H-NMR) | (VPO) | (GPC) | PD |
| Oligomer^{a)} | % by mass | mol % | % by mass | g · mol⁻¹ | g · mol⁻¹ | g · mol⁻¹ | g · mol⁻¹ | (GPC) |
| P-LD(12)-1000 | 15 | 9 | 12 | 1100 | 980 | 1200 | 1300 | 1.58 |
| P-LD(15)-2000 | 15 | 11 | 15 | 2100 | 2600 | 1800 | 2900 | 1.39 |
| P-LD(13)-5000 | 15 | 10 | 13 | 5200 | 5900 | 3300 | 7100 | 1.32 |
| P-LD(13)-7000 | 15 | 10 | 13 | 7200 | 7300 | 3500 | 8700 | 1.32 |
| P-LD(12)-10000 | 15 | 9 | 12 | 10100 | 9500 | 4100 | 12300 | 1.37 |
| P-LD(8)-10000 | 10 | 6 | 8 | 10100 | 6500 | 3900 | 11200 | 1.26 |
| P-LD(17)-10000 | 20 | 12 | 17 | 10100 | 6300 | 4100 | 12300 | 1.37 |
| P-LD(20)-10000 | 20 | 15 | 20 | 10100 | 7200 | n.d.^{c)} | n.d.^{c)} | n.d.^{c)} |
| P-LD(25)-10000 | 30 | 19 | 25 | 10100 | 6900 | 4400 | 10900 | 1.29 |
| P-LD(45)-10000 | 50 | 37 | 45 | 10100 | 10100 | 3200 | 11100 | 1.25 |
| P-LD(65)-10000 | 70 | 56 | 65 | 10100 | 10000 | 2500 | 9400 | 1.21 |

^{a)}See above.
^{b)}The molar proportion of β-hydroxyethoxy acetate units χ_{D} is calculated by evaluating the ¹H-NMR spectra and converted into proportions by mass μ_{D}. The determination of the composition of the oligomers and the calculation of Mₙ according to ¹H-NMR.
^{c)}n.d.: not determined.

TABLE 2b
Proportion by mass μ_{PPG} of oligo(propylene glycol), number-average molar mass Mₙ according to ¹H-NMR
spectroscopy (¹H-NMR) or gas permeation chromatography (GPC) and polydispersity PD of
the star-{oligo(propylene glycol)-block-oligo[(rac-lactate)-co-glycolate]}
triols and the macroinitiators. M_{calc} is the number-average molar mass that is expected due to the
initial weight of the reactands. The number-average molar mass of the oligo[(rac-lactate)-co-
glycolate] segments is M_{b-LG} and the proportion of converted terminal groups of the oligo(propylene
glycol) triols D_{P}. The mass proportion of oligo(propylene glycol) used in the reaction batch is μ_{PPG-R}.

| | | | | Mₙ^{b)} | Mₙ | | | |
|---|---|---|---|---|---|---|---|---|
| | μ_{PPG-R} | μ_{PPG}^{b)} | M_{calc}^{c)} | (¹H-NMR) | (GPC) | PD | M_{b-LG}^{b)} | D_{P}^{b)} |
| Oligomer^{a)} | % by mass | % by mass | g · mol⁻¹ | g · mol⁻¹ | g · mol⁻¹ | (GPC) | g · mol⁻¹ | % |
| T-PPG-1000 | 100 | 100 | 1000 | 930 | 1200 | 1.03 | — | 0 |
| T-PPG-1000-b-LG-2000 | 50 | 41 | 2000 | 2300 | 2700 | 1.09 | 440 | 95 |
| T-PPG-1000-b-LG-4000 | 25 | 22 | 4000 | 4200 | 6000 | 2.35 | 1100 | >99 |
| T-PPG-1000-b-LG-6000 | 17 | 14 | 6000 | 6500 | 6600 | 1.33 | 1900 | >99 |
| T-PPG-1000-b-LG-9000 | 11 | 10 | 9000 | 9000 | 8500 | 1.34 | 2700 | >99 |
| T-PPG-3000 | 100 | 100 | 3000 | 3400 | 3600 | 1.07 | — | 0 |
| T-PPG-3000-b-LG-4000 | 75 | 82 | 4000 | 4200 | 6100 | 1.01 | 250 | 95 |
| T-PPG-3000-b-LG-6000 | 50 | 54 | 6000 | 6500 | 11400 | 2.80 | 1000 | 98 |
| T-PPG-3000-b-LG-9000 | 33 | 38 | 9000 | 9100 | 8700 | 1.41 | 1900 | 92 |
| T-PPG-6000 | 100 | 100 | 6000 | 5600 | 7000 | 1.44 | — | 0 |
| T-PPG-6000-b-LG-9000 | 67 | 60 | 9000 | 9300 | 13400 | 1.65 | 1300 | 86 |
| T-PPG-6000-b-LG-12000 | 50 | 48 | 12000 | 11700 | 7600 | 2.56 | 2000 | 76 |

^{a)}See above.
^{b)}The determination of μ_{PPG}, D_{P} and Mₙ (¹H-NMR) is done using¹H-NMR spectroscopy.
^{c)}Mₙ of the macroinitiators according to the manufacturer's information is the basis for the values n_{I} and M_{I}.

### Networks

The network synthesis takes place by means of polyaddition of the star-shaped macrotriols and tetrols with an aliphatic diisocyanate as a bifunctional coupling reagent (Type 1). Work is done here in solutions in dichloromethane. In standard experiments, an isomer mixture of 2,2,4 and 2,4,4 trimethylhexane-1,6-diisocyanate (TMDI), for example, is used as the diisocyanate. The intended purpose of the use of the isomer mixture is to prevent possible crystallization of diurethane segments. Also suitable are other diisocyanates.

Alternatively, mixtures of different prepolymers can be reacted with a diisocyanate, e.g., oligo(rac-lactate)-co(glycolate) tetrol with oligo(propylene glycol)triol and TMDI (Type II).

A different synthesis strategy is applied in the case of networks of Type III. In this case, a mixture of a tetrol, an oligo(propylene glycol)dimethacrylate and TMDI is produced. First the tetrol and the TMDI react together into a first network (pre-IPN). Subsequently, the radical cross-linking of the dimethacrylate is initiated by means of UV radiation, by means of which a second network is created (sequential IPN). As a result of the use of pre-IPNs, the permanent shape of the shape memory materials can be relatively easily and quickly adjusted to special requirements and geometries by means of UV radiation (FIG. F).

Another synthesis strategy consists of swelling a polyurethane network of Type I in an acrylate, and subsequently triggering a radical polymerization using UV light. Suitable are ethyl, butyl, hexyl or (2-hydroxyethyl)acrylate. In this way, one obtains an IPN of Type IV. Regardless of the acrylate used, two glass transitions are usually observed. When 2-(hydroxyethyl)acrylate is used, it is possible to adjust the hydrophilicity of the material (FIG. G). The bandwidth of medical applications of the prepared materials is expanded because of this possibility.

TABLE 2
Gel content G and degree of swelling Q in chloroform as well as
glass transition temperature T_{g} according to DSC (2^{nd} heating
process) of networks of P-LG(17)-1000 or P-LG(17)-10000 with various
diisocyanates or isomer mixtures of diisocyanates (Type 1).

| | | Mₙ (prepolymer) | | | |
|---|---|---|---|---|---|
| | | according to ¹H- | | | |
| | | NMR | G | Q | T_{g} |
| Diisocyanate | Isomers | g · mol⁻¹ | % by mass | % by vol. | ° C. |
| | — | 820 | 100 | n.d. ^{d)} | 59 |
| | | 10500 | 96 ± 1 | 490 ± 0 | 54 |
| | | 820 | n.d. ^{d)} | 160 ± 40 | 66 |
| | | 10500 | 98 ± 2 | 690 ± 70 | 53 |
| | | 820 | 100 | n.d. ^{d)} | 72 |
| | | 10500 | 98 | 470 ± 10 | 57 |
| | | 820 | 99 | n.d. ^{d)} | 75 |
| | | 10500 | 98 | 460 ± 10 | 57 |
| | | 820 | 97 ± 1 | n.d. ^{d)} | 80 |
| | | 10500 | 100 | 480 | 57 |

^{a)} Isomer mixture of 2,2,4 and 2,4,4-trimethylhexane-1,6-diisocyanate;
^{b)} cis/trans mixture of the isophorone diisocyanate,
^{c)} cis/trans mixture of the 4,4′-methylene-bis(cyclohexyl isocyanate),
^{d)} n.d.: not determined. Networks of P-LG(17)-1000 are destroyed during the swelling in chloroform, so that determination of G and Q are only possible with restrictions.

TABLE 2a
Gel content G and theoretical number-average molar mass M_{c-ideal} of the segments
of networks of oligo[(rac-lactate-co-(β-hydroxyethoxy acetate)] tetrols and TMDI
(Type 1). The values for M_{C-ideal} are calculated with the number-average molar mass of
the oligomers according to¹H-NMR spectroscopy. The number-average molar mass of the
free elastic chains M_{c-affin} and M_{C-Phantom} is determined by using the degree of
swelling Q in chloroform, on the basis of the affine or phantom network model.

| | G | Q | M_{c-ideal} | M_{c-affin} ^{b)} | M_{C-Phantom} ^{b)} |
|---|---|---|---|---|---|
| Network ^{A)} | % by mass | % by vol. | g · mol⁻¹ | g · mol⁻¹ | g · mol⁻¹ |
| N-P-LD(12)-1000 | 100^{c)} | n.d. ^{d)} | 700 | n.d. ^{d)} | n.d. ^{d)} |
| N-P-LD(15)-3000 | 100 | 310 | 1500 | 1700 | 1100 |
| N-P-LD(13)-5000 | 100 | 590 | 3200 | 7200 | 4200 |
| N-P-LD(13)-7000 | 100 | 500 ± 10 | 3900 | 5000 ± 200 | 3000 ± 100 |
| N-P-LD(12)-10000 | 92 ± 1 | 860 ± 50 | 5000 | 15400 ± 1600 | 8700 ± 1000 |
| N-P-LD(8)-10000 | 98 ± 0 | 610 | 3400 | 7600 | 4500 |
| N-P-LD(17)-10000 | 93 ± 1 | 820 ± 10 | 3400 | 14000 ± 300 | 8000 ± 200 |
| N-P-LD(20)-10000 | 97 ± 1 | 560 | 3700 | 6400 | 3800 |
| N-P-LD(25)-10000 | 91 ± 2 | 690 ± 30 | 3800 | 9900 ± 900 | 5700 ± 500 |
| N-P-LD(45)-10000 | 93 ± 1 | 760 ± 30 | 5300 | 12000 ± 1000 | 6900 ± 500 |
| N-P-LD(65)-10000 | 90 | 870 ± 80 | 5200 | 15800 ± 2900 | 8900 ± 1600 |

^{a)} See above.
^{b)} The solubility parameter δ_{P} is only insubstantially influenced by the β-hydroxyethoxy acetate content. For PPDO, a value of 19.0 MPa^{0.5}, which corresponds to the value for PDLLA, is determined according to the group contribution method with molar attraction constants according to Small. All calculations therefore take place with a value for the interaction parameter x of 0.34. The density of the amorphous networks ρₚ is always set equal to 1.215 g · cm⁻³.
^{c)} The determination of G is done by means of extraction with a mixture of diethyl ether and chloroform in a proportion by volume of roughly 1:1.
^{d)} n.d.: not determined. Networks are destroyed during the swelling process in chloroform.

TABLE 3b
Gel content G and mass-related degree of swelling S in chloroform
of networks of star-{oligo(propylene glycol)-block-oligo[(rac-
lactate)-co-glycolate]} triols and TMDI (Type I).

| | G | S |
|---|---|---|
| Network ^{a)} | % by mass | % by mass |
| N-T-PPG-1000 | 97 ± 2 | n.d. ^{b)} |
| N-T-PPG-1000-b-LG-2000 | 97 ± 2 | 350 ± 10 |
| N-T-PPG-1000-b-LG-4000 | 93 ± 4 | 870 ± 60 |
| N-T-PPG-1000-b-LG-6000 | 94 ± 0 | 960 ± 10 |
| N-T-PPG-1000-b-LG-9000 | 90 ± 1 | 1390 ± 130 |
| N-T-PPG-3000 | 98 ± 1 | 700 ± 10 |
| N-T-PPG-3000-b-LG-4000 | 94 ± 1 | 1330 ± 400 |
| N-T-PPG-3000-b-LG-6000 | 73 | 3670 |
| N-T-PPG-3000-b-LG-9000 | 58 | 3650 ± 780 |

^{a)} See above.
^{b)} n.d.: not determined, is destroyed during swelling in chloroform.

TABLE 2c
Gel content G and mass-related degree of swelling S in chloroform,
proportion by mass μ_{PPG-R} of oligo(propylene glycol) in reaction
batch and proportion by mass μ_{PPG} determined by means of¹H-NMR-
spectroscopy in networks of P-LG(17)-10000, oligo(propylene glycol)
triols of varying molar weight and TMDI (Type II).

| | μ_{PPG-R} | μ_{PPG} ^{b)} | G | S |
|---|---|---|---|---|
| | % by | % by | % by | % by |
| Network ^{a)} | mass | mass | mass | mass |
| N-P-LG(17)-10000 | — | — | 98 ± 2 | 830 ± 80 |
| N-T-PPG(10)-1000-LG | 10 | n.d. ^{c)} | 98 ± 8 | 680 ± 70 |
| N-T-PPG(20)-1000-LG | 20 | 10 | 91 ± 1 | 740 ± 20 |
| N-T-PPG(30)-1000-LG | 30 | 28 | 94 ± 1 | 720 ± 30 |
| N-T-PPG(50)-1000-LG | 50 | 39 | 94 ± 7 | 830 ± 130 |
| N-T-PPG(70)-1000-LG | 70 | 68 | 79 ± 3 | 1750 ± 70 |
| N-T-PPG-1000 | 100 | n.d. ^{c)} | 97 ± 2 | n.d. ^{c)} |
| N-T-PPG(10)-3000-LG | 10 | n.d. ^{c)} | 96 ± 8 | 810 ± 40 |
| N-T-PPG(20)-3000-LG | 20 | 16 | 92 ± 1 | 770 ± 40 |
| N-T-PPG(30)-3000-LG | 30 | 28 | 92 ± 10 | 970 ± 20 |
| N-T-PPG(50)-3000-LG | 50 | 57 | 902 ± 12 | 1340 ± 90 |
| N-T-PPG(70)-3000-LG | 70 | n.d. ^{c)} | 67 | 2640 |
| N-T-PPG-3000 | 100 | n.d. ^{c)} | 98 ± 1 | 700 ± 10 |

^{a)} See above.
^{b)} Determined by means of¹H-NMR spectroscopic examinations after reaction of the contained networks with deuterated trifluoroacetic acid.
^{c)} n.d.: not determined.

TABLE 2d
Mass-related degree of swelling S in chloroform and proportion
by mass μ_{PPG-R} of oligo(propylene glycol) in reaction batch
of interpenetrating polymer networks of P-LG(17)-10000, TMDI and
M-PPG-560. For comparison, the mass-related degree of swelling
of the network N-P-LG(17)-10000 (Type III) is also shown.

| | μ_{PPG-R} | S ^{b)} |
|---|---|---|
| IPN ^{a)} | % by mass | % by mass |
| N-P-LG(17)-10000 | 0 | 830 ± 80 |
| N-LG-ip-N-M-PPG(10) | 10 | 690 ± 190 |
| N-LG-ip-N-M-PPG(20) | 20 | 630 ± 30 |
| N-LG-ip-N-M-PPG(30) | 30 | 640 ± 40 |
| N-LG-ip-N-M-PPG(50) | 50 | 540 ± 20 |

^{a)} See above.
^{b)} IPNs break during the swelling.

TABLE 2e
Mechanical properties of network systems at 25° C. that are obtained by means of
coupling oligo[(rac-lactate)-co-glycolate] tetrols with TMDI and oligo(propylene
glycol) dimethacrylates before and after UV radiation has taken place. E is the E
module, σs the yield stress, εₛ the apparent yield point, σ_{b} the breakage
stress and ε_{b} the elongation at break.

| | E | σ_{S} | εₛ | σ_{b} | ε_{b} |
|---|---|---|---|---|---|
| Network ^{a)} | MPa | MPa | % | MPa | % |
| N-P-LG(17)-10000 | 340 ± 60 | 40.0 ± 5.0 | 8 ± 3 | 36.2 ± 5.9 | 250 ± 210 |
| N-LG-ip-M-PPG(10) | 115 ± 40 | 17.1 ± 3.2 | 24 ± 8 | 15.1 ± 3.2 | 370 ± 115 |
| N-LG-ip-M-PPG(20) | 20 ± 3 | — | — | 11.5 ± 3.4 | 660 ± 200 |
| N-LG-ip-M-PPG(30) | 15 ± 10 | — | — | 8.4 ± 1.3 | 635 ± 115 |
| N-LG-ip-M-PPG(50) | 1.5 ± 0.3 | — | — | 2.2 ± 0.2 | 500 ± 125 |
| N-LG-ip-N-M-PPG(10) | 350 ± 10 | 35.4 ± 1.7 | 13 ± 3 | 27.5 ± 3.2 | 260 ± 110 |
| N-LG-ip-N-M-PPG(20) | 415 ± 90 | 39.3 ± 1.3 | 10 ± 2 | 36.2 ± 2.9 | 230 ± 20 |
| N-LG-ip-N-M-PPG(30) | 270 ± 80 | 32.4 ± 3.5 | 17 ± 2 | 33.3 ± 6.8 | 225 ± 45 |
| N-LG-ip-N-M-PPG(50) | 150 ± 30 | 23.2 ± 4.6 | 24 ± 3 | 28.1 ± 3.5 | 105 ± 20 |
| N-M-PPG-560 | 22 ± 7 | — | — | 3.1 ± 1.0 | 15 ± 5 |

^{a)} See above.

TABLE 3
Glass transition temperatures T_{g1} and T_{g2} (DSC, 2^{nd} heating process
at a heating rate of 30 K · min⁻¹) and changes to the isobaric heat
capacity ΔCₚ₁ and ΔCₚ₂ at the glass transitions of IPNs that are
produced by swelling the network N-P-LG(17)-10000 in acrylate solutions
and subsequent radiation (Type IV). For comparison, the thermal
properties of the networks N-EA, N-BA and N-HEA are listed.

| | T_{g1} | ΔCₚ₁ | T_{g2} | ΔCₚ₂ |
|---|---|---|---|---|
| Network^{a)} | ° C. | J · K^{-1·} g⁻¹ | ° C. | J · K^{-1·} g⁻¹ |
| N-P-LG(17)-10000 | —^{b)} | —^{b)} | 61 | 0.50 |
| N-LG-ip-N-EA(15) | —^{b)} | —^{b)} | 56 | 0.34 |
| N-LG-ip-N-EA(19) | —^{b)} | —^{b)} | 56 | 0.39 |
| N-LG-ip-N-EA(38) | 0 | 0.02 | 56 | 0.16 |
| N-LG-ip-N-EA(55) | 1 | 0.12 | 45 | 0.04 |
| N-EA | −7 | 0.40 | —^{b)} | —^{b)} |
| N-LG-ip-N-BA(8) | —^{b)} | —^{b)} | 62 | 0.39 |
| N-LG-ip-N-BA(14) | —^{b)} | —^{b)} | 58 | 0.35 |
| N-LG-ip-N-BA(19) | —^{b)} | —^{b)} | 57 | 0.37 |
| N-LG-ip-N-BA(36) | −43 | 0.08 | 57 | 0.21 |
| N-LG-ip3-N-BA(81) | −36 | 0.49 | 57 | 0.07 |
| N-BA | −38 | 0.61 | —^{b)} | —^{b)} |
| N-LG-ip-N-HEA(30) | −4 | 0.10 | 51 | 0.31 |
| N-LG-ip-N-HEA(50) | −2 | 0.06 | 51 | 0.15 |
| N-LG-ip-N-HEA(59) | 2 | 0.11 | 51 | 0.13 |
| N-LG-ip-N-HEA(61) | 9 | 0.04 | 53 | 0.09 |
| N-HEA | −1 | 0.31 | —^{b)} | —^{b)} |

^{a)}See above.
No thermal transition is detected in the case of the network system N-LG-ip2-N-BA(56).
^{b)}A second glass transition is not detected.

### Shape Memory Properties

TABLE 4
Elongation fixation ratio R_{f}(N), elongation restoration ratio Rᵣ(N) and E module E(N)
(70° C.) in cycle N of networks of oligo[(rac-lactate)-co-glycolate] triols or
tetrols with constant glycol content and TMDI at the reached stretching εₘ in controlled-
position, cyclic thermomechanical experiment under standard condition.

| | εₘ | R_{f}(1) | Rᵣ(1) | R_{f}(2-5) | Rᵣ(2-5) | E(1) | E(2-5) |
|---|---|---|---|---|---|---|---|
| Network^{a)} | % | % | % | % | % | MPa | MPa |
| N-T-LG(17)-5000 | 50^{b)} | 91.3 | 98.5 | 94.6 ± 2.7 | 98.6 ± 0.9 | 2.04 | 1.68 ± 0.25 |
| N-T-LG(17)-7000 | 100 | 94.3 | >99 | 94.3 ± 0.1 | 99.3 ± 0.4 | 1.00 | 0.71 ± 0.13 |
| N-T-LG(16)-9000 | 100 | 95.5 | >99 | 91.2 ± 0.3 | 98.8 ± 0.5 | 0.89 | 0.69 ± 0.02 |
| N-T-LG(18)-12000 | 100 | 91.8 | 97.3 | 91.7 ± 0.1 | 96.9 ± 0.4 | 0.70 | 0.35 ± 0.10 |
| N-P-LG(15)-5000 | 50^{b)} | 90.3 | >99 | 91.1 ± 2.4 | 96.4 ± 1.3 | 1.68 | 1.75 ± 0.12 |
| N-P-LG(15)-7000 | 100 | 92.0 | >99 | 92.3 ± 0.1 | >99 | 1.63 | 1.60 ± 0.03 |
| N-P-LG(16)-9000 | 100 | 95.8 | >99 | 96.8 ± 2.1 | 98.6 ± 1.6 | 0.53 | 0.52 ± 0.01 |
| N-P-LG(17)-10000 | 100 | 96.5 | 92.6 | 95.0 ± 0.0 | 90.1 ± 0.9 | 2.03 | 1.70 ± 0.12 |
| N-P-LG(12)-12000 | 100 | 92.8 | 94.8 | 94.6 ± 2.7 | 90.9 ± 3.5 | 1.18 | 0.78 ± 0.11 |

^{a)}See above.
^{b)}The samples break when the value of εₘ is 100%.

The examples according to the invention demonstrate that the networks of the invention are shape memory materials that can be selectively produced, wherein good control of the network properties is possible. Preferred networks are amorphous and biodegradable and/or phase-segregated.

1. Polymeric networks, obtainable by the reaction of hydroxytelechelic prepolymers, wherein the prepolymers comprise polyester and/or polyether segments, with diisocyanate.

2. Polymeric network according to claim 1, wherein the prepolymers have units derived from lactic acid, caprolactone, dioxanone, glycolic acid, ethylene glycol and/or polypropylene glycol.

3. Polymeric network according to claim 1 or 2, wherein the prepolymers have a number-average molecular weight of from 1,000 to 15,000 g/mol.

4. Polymeric network according to one of the preceding claims, comprising a second network that is not covalently connected to the polymeric network, but that rather only penetrates this polymeric network (IPN), wherein the second network is a network derived from acrylate monomers or polypropylene glycol macromonomers.

5. Polymeric network according to one of the preceding claims, wherein the prepolymer comprises units derived from lactic acid and glycolic acid, lactic acid and caprolactone, lactic acid and dioxanone or lactic acid and propylene glycol.

6. Polymeric network according to claim 5, wherein the prepolymer comprises units derived from lactic acid and propylene glycol and wherein these units are present in a block-like distribution.

7. Polymeric network according to one of the preceding claims, wherein the prepolymer has a central unit derived from a trifunctional or tetrafunctional compound.

8. Polymeric network according to claim 7, wherein the trifunctional or tetrafunctional compound is 1,1,1-tris(hydroxymethyl)ethane or pentaerythritol.

9. Polymeric network according to one of the preceding claims, obtainable by means of the reaction of two or three different prepolymers.

10. Method for the production of a polymeric network according to one of the claims 1 to 9, comprising the reaction of hydroxytelechelic prepolymers, wherein the prepolymers comprise polyester and/or polyether segments, with diisocyanate.

11. Method according to claim 10, wherein the prepolymers have units derived from lactic acid, caprolactone, dioxanone, glycolic acid, ethylene glycol and/or polypropylene glycol.

12. Method according to claim 10 or 11, wherein the prepolymers have a number-average molecular weight of from 1,000 to 15,000 g/mol.

13. Method according to one of the preceding claims 10 to 12, comprising a further stage of the production of a second network that is not covalently connected to the polymeric network, but that rather only penetrates this polymeric network (IPN), wherein the second network is a network obtained by means of the polymerization of acrylate monomers or polypropylene glycol macromonomers.

14. Method according to one of the preceding claims 10 to 13, wherein the prepolymer comprises units derived from lactic acid and glycolic acid, lactic acid and caprolactone, lactic acid and dioxanone or lactic acid and propylene glycol.

15. Method according to claim 14, wherein the prepolymer comprises units derived from lactic acid and propylene glycol and wherein these units are present in a block-like distribution.

16. Method according to one of the preceding claims 10 to 15, wherein the prepolymer has a central unit derived from a trifunctional or tetrafunctional compound.

17. Method according to claim 16, wherein the trifunctional or tetrafunctional compound is 1,1,1-tris(hydroxymethyl)ethane or pentaerythritol.

18. Method according to one of the preceding claims 10 to 17, comprising the reaction of two or three different prepolymers.
